(19) United States
(12) Patent Application Publication
(10) Pub. No.: US 2005/0212310 A1
(43) Pub. Date: Sep. 29, 2005

(54) Device for protecting the front chin spoiler of an automobile

(76) Inventor: Paul Yukhon Viriyapanthu, Garden Grove, CA (US)

Correspondence Address: Paul Yukhon Viriyapanthu, 12072 Henry Evans Drive, Garden Grove, CA, 92840, US

(21) Appl. No.: 10/810,264

(22) Filed: Mar. 24, 2004

(51) Int. Cl. B60R 19/02

(52) U.S. Cl. 293/102

(57) ABSTRACT

A device for protecting the front chin spoiler of an automobile from damage resulting from contact with the road surface by clamping a guard to the underside and front of the automobile's chin spoiler. The invention contains a metal plate base unit which is composed of a sheet of metal (10) in which one end (14) has been bent or form molded upwards and upon itself to be perpendicular (16) with its horizontal length, forming a vertical post in the approximate shape of the letter “D”, that is clamped to an automobile's chin spoiler by use of a sliding unit (12) that has been formed by bending and welding or form molding, to form a rectangular box. The sliding unit fits over the base unit and slides across the flat, horizontal length of the base unit, and has a vertical post (24) protruding on the side facing the interior side of the chin spoiler, and a threaded screw on the underside (26) which, when extended, clamps the sliding unit to the base unit and prevents it from moving. To install, the user firmly presses the perpendicular post (16) of the base unit against the exterior side of the chin spoiler, and firmly presses the vertical wall (24) of the sliding unit (12) against the interior wall of the chin spoiler, then tightens the threaded screw on the underside of the sliding unit (26) until the invention is clamped into place.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention relates to protecting the front chin spoiler of an automobile from scraping on a driveway or other inclined driving surface and from damage caused by forward driving into a parking curb.

2. Background of the Invention

In order to improve aerodynamic flow, and enhance appearance, many automobiles are equipped with front chin spoilers, also referred to as air dams, or front valences. Often these devices are made of fiberglass or plastic, and are usually painted to match the color of the vehicle. The construction of these devices makes them fragile and susceptible to damage from contact with the road surface. The placement of these devices causes the clearance between the chin spoiler to be only a few inches from the surface of the roadway, and a problem often arises when a vehicle is driven on a driveway with an inclined surface which causes the lower part of the chin spoiler to scrape against the road surface. The problem is further exacerbated when a vehicle is lowered by the owner or with the use of aftermarket chin spoilers that are often lower to the ground than similar factory installed spoilers.

Similarly, damage to the chin spoiler also often results during the parking of a vehicle where the driver misjudges the distance and drives too far forward, causing the ‘face portion’ of the chin spoiler, the front vertical surface which channels airflow, to come into contact with the curb or concrete parking blocks demarcating parking spaces.

After a diligent search, applicant has been unable to find any devices designed to protect the chin spoiler of a vehicle from scraping on the surface of the roadway of a driveway or inclined driving surface. There have been devices designed to protect a vehicle from collision with a curb during parking maneuvers. For example D344,035 (1992), a combination curb feeler and alarm, and 393937 (1976) a curb feeler. These designs suffer from a number of disadvantages:

(a) Such devices only alert the driver of the vehicle when an impact with a curb is imminent, but they do not protect against the actual impact itself.

(b) Such devices are only useful for parallel parking circumstances, and not designed to be used in a forward parking spot situation.

(c) None of the devices protects the underside of a chin spoiler from damage as a result of driveways or other inclined driving surfaces.

### BACKGROUND OF INVENTION

Objects and Advantages

The objects and advantages of the present invention, the chin spoiler guard, are:

(a) to protect the bottom portion of an automobile's chin spoiler from damage resulting from scraping on driveways or other inclined roadways;

(b) to protect the vertical face portion of the chin spoiler from damage as a result of an impact with a parking curb when the driver pulls too far forward during parking maneuvers.

### SUMMARY

The present invention is a device that is attached the underside of a chin spoiler and protects the chin spoiler from damage from contact with the road surface and frontal impact with a parking curb. The device, the chin spoiler guard, is attached to the bottom part of the chin spoiler, on the area directly above and closest to and the road surface. When the vehicle is driven upon a driveway or other inclined road surface, the device is designed to come into contact with the road surface before any contact is made between the road surface and the chin spoiler. The device will bear the brunt of the impact from contact with the road surface and frontal impact with a parking curb, thus protecting the chin spoiler.

### DRAWINGS

Figures

FIG. 1 shows a ¾ view of the device showing the two component parts, the bent plate, that comprises the base plate unit, and the sliding unit when fitted together.

FIG. 2 shows only the moveable sliding unit of the invention that clamps to the larger base plate unit by use of a threaded screw on the underside (shown). The raised post of the sliding unit clamps against the inside lip of a chin spoiler.

FIG. 3 shows a side profile of the device, and fitment to the chin spoiler of an automobile (shown in dashed lines). The vertical post of the base plate unit presses against the outside, lower lip of the chin spoiler. The sliding unit, when fitted to the base unit, is moved so that the protruding post of the sliding unit presses against the interior lip of the automobile's chin spoiler, and is secured by turning the threaded screw on the underside of the sliding unit, preventing movement along the length of the base plate unit. The tension of the base plate unit against the outside of the chin spoiler and the sliding unit against the interior lip of the chin spoiler clamps the device to the chin spoiler.

FIG. 4 shows the ¾ view of the appearance of the device when attached to an automobile (shown in dashed lines).

FIG. 5 shows a side profile of the alternative embodiment of the device with the exterior facing post of the device made at an angle.

FIG. 6 shows a side profile of the alternative embodiment of the device lacking the frontal protrusion. This embodiment has fixed vertical posts and the exterior post is set at an angle. In this embodiment, the device is specially manufactured to fit a specific chin spoiler. The angled exterior post is made at the same angle as, and presses against, the exterior surface of the chin spoiler. The interior post is positioned to press against the interior surface edge of the chin spoiler. The device is secured into position by the insertion of a threaded screw into a threaded hole on the interior post of the alternative embodiment. The hole is manufactured at such a height that when a threaded screw is inserted, said screw presses against the uppermost horizontal surface of the interior of the chin spoiler and thus prevents movement of the interior post down and off the chin spoiler.

FIG. 7 shows a ¾ view of the alternative embodiment of the device with fixed vertical posts and the exterior facing post at an angle.

FIG. 8 shows a ¾ view of the appearance of an alternative embodiment of the device when attached to an automobile (shown in dashed lines).

### DRAWINGS

Reference Numerals

10 base plate unit
12 sliding unit
14 curved protrusion of the base unit which protects from frontal impact
16 vertical post which presses against the outer surface of the chin spoiler
18 rubber padding on vertical post of base plate
20 rubber padding on horizontal length of base plate unit
22 raised post which presses against inner surface of chin spoiler
24 threaded hole
26 readed hole for screw which clamps sliding unit to base unit
28 rubber padding on rear vertical post
30 notched protrusion on rubber padding
32 threaded screw

### DETAILED DESCRIPTION

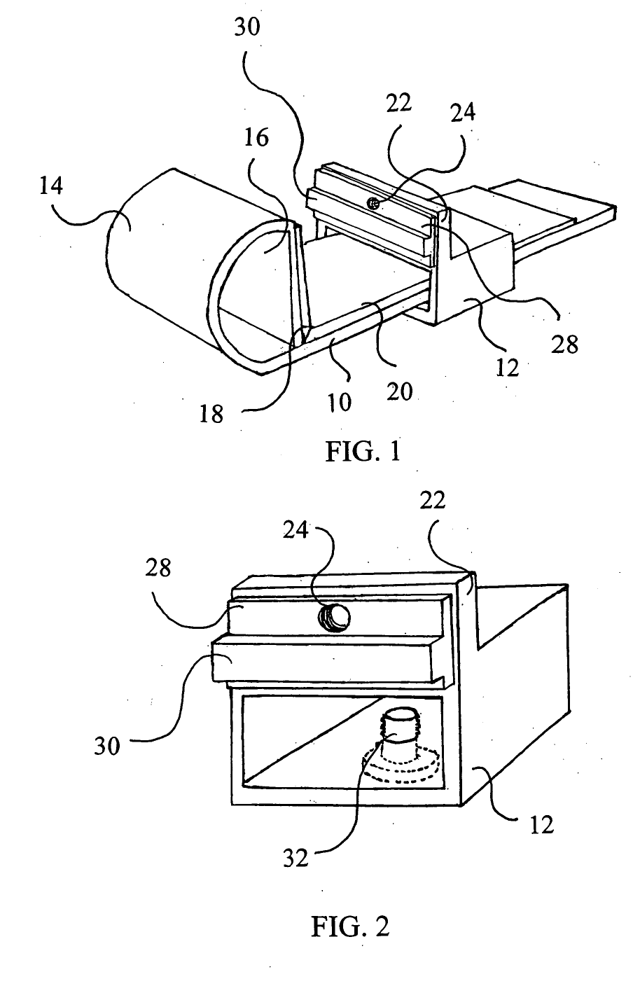

FIGS. 1, 2, 3, and 4

### PREFERRED EMBODIMENT

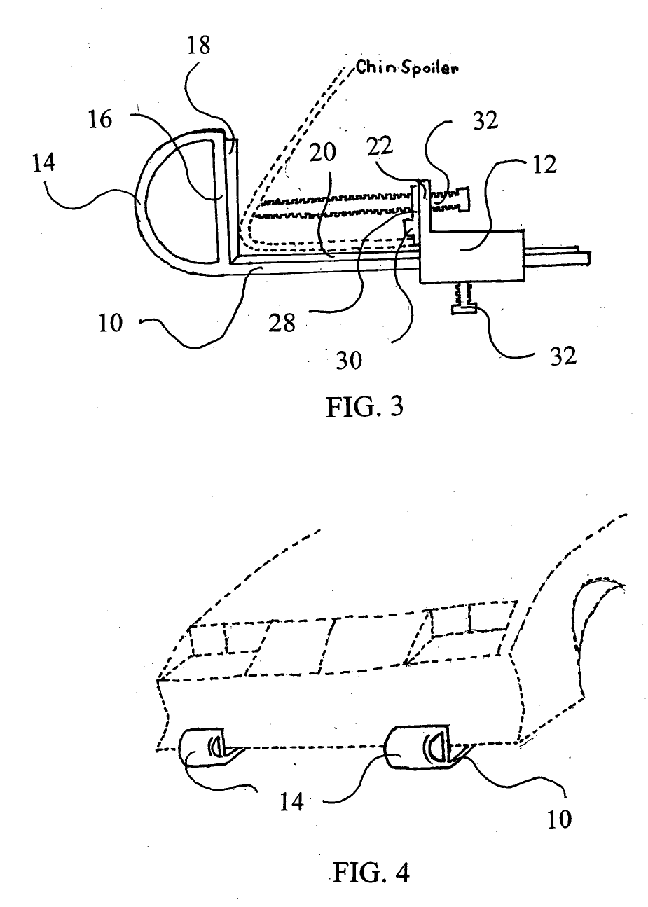

A preferred embodiment of the present invention is illustrated in FIG. 1 (frontal ¾ view), FIG. 2 (frontal ¾ view of the sliding unit only), FIG. 3 (side view), ans FIG. 4 (frontal ¾ view of device when attached to automobile). The base unit 10 consists of a rectangular metal plate with a metal protrusion that has been shaped from the plate by bending or forging to form a curve 14 in the shape of a half circle which, at the apex of the half circle, turns into a straight vertical post 16 approximately perpendicular to the horizontal length of the base plate unit in the shape of the letter “D”; the vertical post 18 presses against the outer surface of the chin spoiler, and, in conjunction with the sliding unit, creates tension which clamps the entire invention onto the chin spoiler.

In the preferred embodiment, the base plate unit is made of metal, such as steel or aluminum. Such material may be purchased from U.S. Steel or Alcoa. However, the base unit may be made of any solid, rigid material such as plastic, rubber, vinyl, nylon, various impregnated, laminated or plasticized material. The dimensions of the base plate unit are approximately 6 to 12 centimeters wide, with the length of approximately 16 centimeters to 40 centimeters. The variations in size are due to the fact that the invention may need to be made in different sizes to accommodate a particular vehicle. The thickness of the material comprising the base unit is approximately 2 to 7 millimeters.

The top of the flat, horizontal surface of the base unit is affixed a sheet of rubber padding 20 which is approximately 2 to 5 millimeters in thickness, and which is attached to the base unit by adhesive. The vertical surface of the base unit 16 has a sheet of rubber padding 18 that is attached to the base unit by adhesive. The purpose of the rubber padding is to prevent scratching of the chin spoiler while the invention is attached.

The sliding unit 12 is composed of metal that has been formed by bending and welding, or form molding, to form a rectangular box. The sliding unit fits over the base plate unit and slides across the flat, horizontal length of the base unit. The dimensions of the sliding unit are approximately 3 to 6 centimeters in length, and approximately 1.5 to 3 centimeters in height.

The thickness of the sliding unit is approximately 2 to 5 millimeters in thickness. In the preferred embodiment, the sliding unit is made of metal, such as steel or aluminum, and which may be purchased from U.S. Steel or Alcoa. However, the sliding unit may be made of any solid, rigid material such as plastic, rubber, vinyl, nylon, various impregnated, laminated, or plasticized material.

On one side of the sliding unit, the side facing the chin spoiler, there is a vertical post 24 extending approximately 1 centimeter to 10 centimeters in height, and approximately 2 to 5 millimeters in thickness. This variation in size is necessary given that the invention may need to be made in different sizes to accommodate particular vehicles. The purpose of this post is to press against the interior surface of the chin spoiler, and, in conjunction with the tension from the base unit when the two units are secured together, clamp the entire invention to the chin spoiler.

On the side of this post closest to, and facing the interior surface of the chin spoiler, is attached by adhesive a sheet of rubber padding 28 approximately 2 to 5 millimeters thick. The purpose of the rubber padding at this point is two fold. First, the padding protects the chin spoiler from scratching from contact with the guard. Secondly, the rubber padding will conform its shape to the interior surface of the chin spoiler, thus providing better grip against the chin spoiler. In addition, the rubber padding has a protruding notch 30 in the area immediately above the edge where the chin spoiler would rest, to prevent vertical movement of the device down and off the chin spoiler.

Through the post 22 and the rubber padding 28 there is a threaded hole 24. The purpose of this threaded hole is to allow fitment of a threaded screw running the length from the sliding unit to the inside wall of the automobile's chin spoiler. The attachment of this additional screw provides an additional securing point by pressing against the inside surface of the chin spoiler. In addition, the screw will limit the downward vertical movement of the sliding unit and prevents the device from falling off completely should the wall of the sliding unit become dislodged from the interior of the chin spoiler.

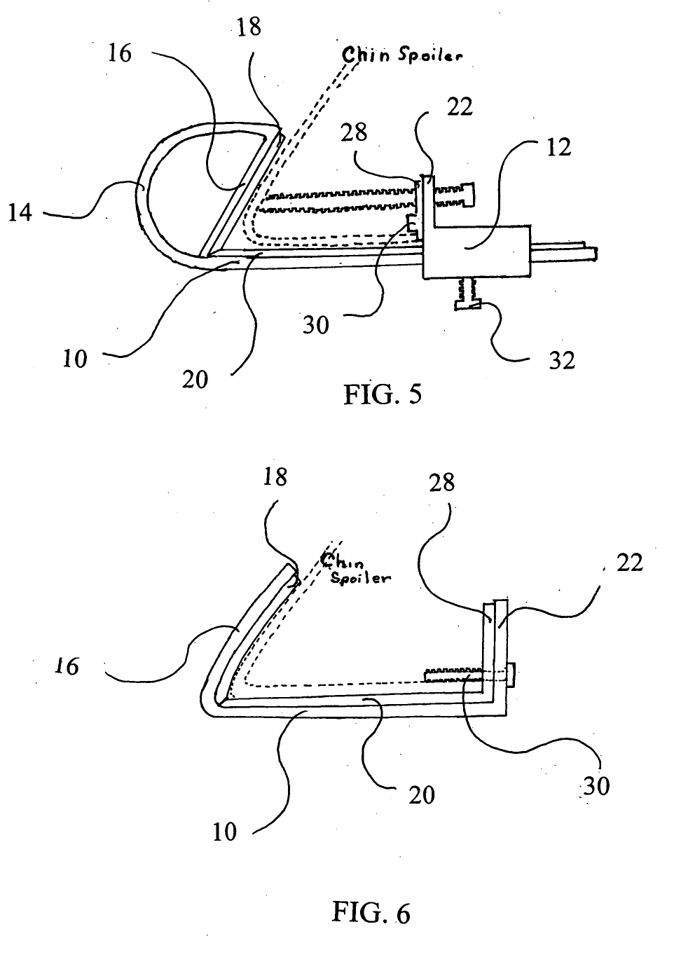

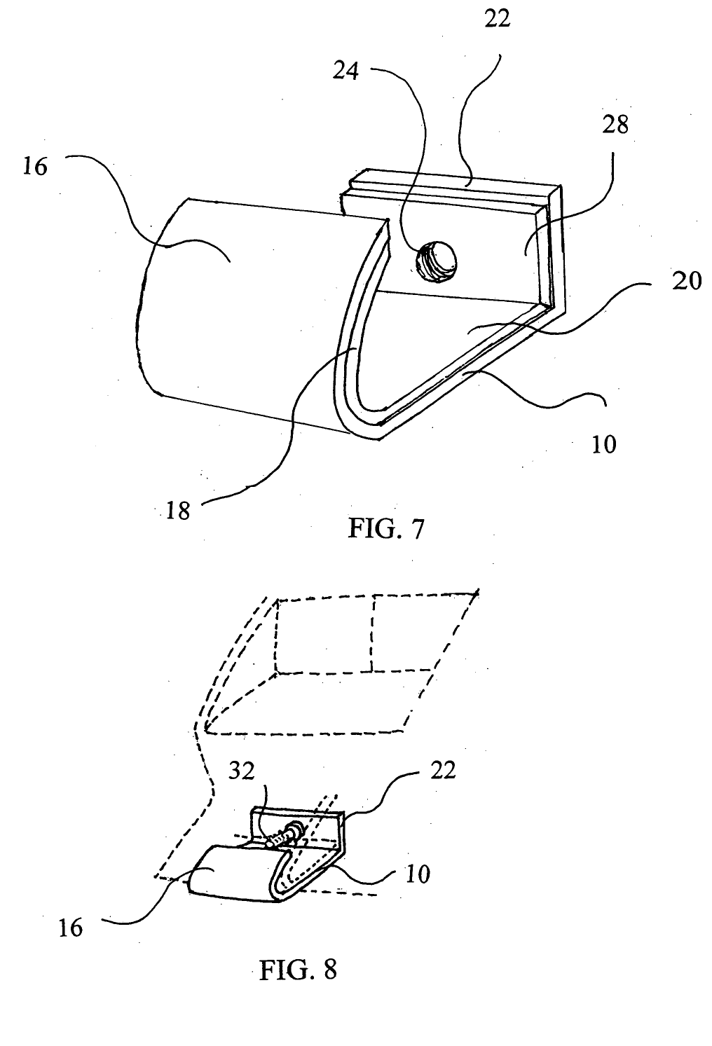

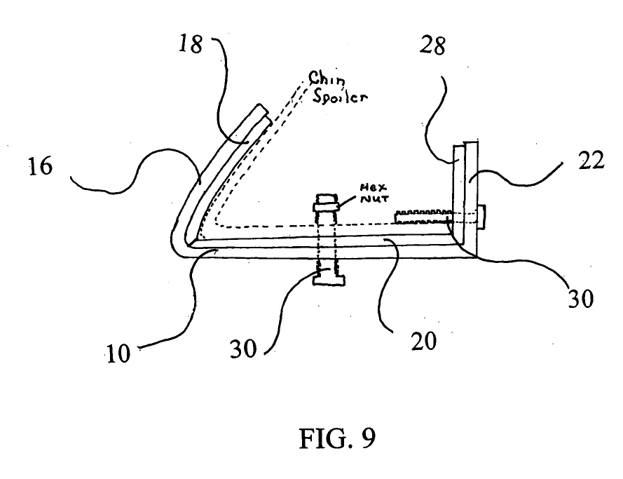

FIGS. 5-9—Alternative Embodiments

There are various possibilities with regard to varying particular aspects of the invention. The preferred embodiment provides a generally universal fitment of the device to nearly all automobiles as the distance between the posts is adjustable. Automobile design and construction may require that the invention be altered in order to fit a particular vehicle, or, in the alternative, the purchaser may prefer a different aesthetic. An alternative embodiment is shown in FIG. 5 where the vertical portion 16 of the base unit, which comes into contact with the outside surface of the chin spoiler, has been made at an angle. FIGS. 6,7, 8, and 9 illustrates an alternative embodiment of the invention which has fixed vertical posts and need not be adjustable. In this embodiment, the measurements of the device are custom manufactured to fit a particular automobile. The alternative embodiment invention does not incorporate the curved portion 14 that protects against frontal impact with a parking curb. The alternative embodiment is mounted similarly to the preferred embodiment by pressing the vertical posts against the exterior and interior surfaces of the chin spoiler. The alternative embodiment has a threaded hole on the interior post, similar to the preferred embodiment, but placed at a lower height such that when a threaded screw is inserted, it presses against the top horizontal surface of the interior of the chin spoiler and secures the device. FIG. 9 shows an additional embodiment with the addition of threaded holes on the underside of the horizontal plate that allows for direct bolting to corresponding holes on the chin spoiler.

Operation—FIGS. 1, 2, 3, and 4

The manner of using the invention consists of mounting the device to the chin spoiler. The mounting of this device will prevent the chin spoiler from coming into direct contact with the surface of the road. Once securely mounted, no further operation is required of the user.

To mount the invention, the vertical rubber padded section 18 of the post 22 on the base unit base unit is pressed against the outside, lower portion of the chin spoiler and the rubber padded horizontal potion of the base unit 20 is lifted until it is flush against the bottom portion of the chin spoiler. The sliding unit 12 is attached to the base unit 10 and slid towards the chin spoiler until the post and rubber padding of the sliding unit 24 and 28 makes contact with rear surface of the chin spoiler. The base unit and the sliding unit are pressed close together by the user with the chin spoiler in between the two units. Once sufficient tension exists between the rubber padded vertical post 16 and 18 of the base unit and the vertical rubber padded post 24 and 28 of the sliding unit, the sliding unit is clamped securely onto the base unit by turning of the threaded screw 26 on the underside of the sliding unit. Once the sliding unit and the base unit are clamped together, the two units act as one singular clamp, clamping onto the chin spoiler on said chin spoiler's exterior and interior surfaces.

To remove the invention, the threaded screw 26 is loosened, and the sliding unit is moved away from the base unit until completely removed. Without the tension of the sliding unit clamping the invention to the chin spoiler, the base unit will fall off.

Advantages

From the description above, a number of advantages of my chin spoiler guard become evident:

(a) With the invention attached, the guard will be lower to the ground than the chin spoiler such that when the automobile is driven on a driveway or other inclined surface, the device will come into contact with the road surface before said chin spoiler and bear the brunt of the impact preventing any damage to the chin spoiler itself.

(b) The outward curved portion of the chin spoiler guard protrudes directly in front of the automobile such that if the vehicle is driven too far forward into a parking curbstone, the damage will be borne by the chin spoiler guard instead of the chin spoiler itself.

(c) The chin spoiler guard can be installed and removed without any permanent modification or damage to the automobile.

(d) The chin spoiler guard is easy for the user to install and remove without any complicated tools necessary.

(e) The chin spoiler guard is inexpensive to replace in event of damage.

Conclusion, Ramifications, and Scope

Accordingly, the reader will see that the chin spoiler guard can be utilized as an inexpensive and practical means by which to prevent costly damage to the chin spoiler of an automobile. In addition, without having to be concerned about damage, the owner of the vehicle is given more options in which to customize the vehicle such as by lowering the automobile or by installing more aggressive looking chin spoilers which are often lower to the ground than those which came stock with the vehicle. Furthermore, the chin spoiler guard has the additional advantages in that
the chin spoiler guard can be painted to increase visibility of the vehicle;
by nature of the fact that it clamps the chin spoiler, the guard inhibits the chin spoiler from flexing and thus cracking or splitting the paint;
the guard provides an additional, aggressive look to an automobile.

Although the description above contains many specificities, these should not be construed as limiting the scope of the invention but merely providing illustrations of some of the presently preferred embodiments of this invention. For example, the bent protruding section of the guard, which protects the chin spoiler from frontal collision with a parking curbstone, can be made in different shapes, such as square, rectangle, triangle, trapezoidal, etc.; the portions which require a threaded screw may utilize more than one to secure the device, etc.

Thus the scope of the invention should be determined by the appended claims and their legal equivalents, rather than by the examples given.

1. A device for protecting an automobile chin spoiler from damage resulting from contact with the road surface and comprising:
(a) a protective plate,
(b) and means for mounting the plate to the underside of an automobile chin spoiler.

2. A device for protecting an automobile chin spoiler from damage composed of a flat, horizontal plate with at least one raised, vertical post placed on one end of said plate.

3. The device of claim 2 wherein said vertical post is formed at an angle approximately equal to the angle of the exterior, frontal vertical face of an automobile chin spoiler.

4. The device of claim 2 that contains two vertical posts on opposite ends of said plate with the horizontal length between said posts being fixed and made a predetermined distance apart approximately equal to the length between the outer exterior surface edge and the interior surface edge of an automobile chin spoiler.

5. The device of claim 2 wherein said fixed vertical posts have a sheet of rubber padding attached by adhesive to at least one side.

6. The device of claim 2 wherein the horizontal portion of said plate has a sheet of rubber padding attached by adhesive to at least one side.

7. The device of claim 2 wherein said device is attached by pressing one said vertical post against the exterior surface of an automobile chin spoiler, manipulating the device so that the horizontal surface area of the device presses against the underside of said automobile chin spoiler and the other vertical post presses against the interior surface of said automobile chin spoiler.

8. The device of claim 2 wherein said vertical post that presses against the interior surface of an automobile chin spoiler has at least one drilled threaded hole at a height slightly above the top horizontal surface of the underside of said chin spoiler.

9. The device of claim 2 wherein a threaded screw is inserted through said threaded hole of said vertical post such that, when threaded through said hole, the side of the screw comes into contact with the surface of the chin spoiler.

10. The device of claim 2 wherein said horizontal plate has at least one drilled threaded hole on the underside of the plate as to allow the insertion of a threaded screw and nut into the plate and into a corresponding hole on the underside of the chin spoiler so as to secure the plate and the chin spoiler together.

11. A device for protecting an automobile chin spoiler from damage composed of a flat, horizontal plate with at least one raised, vertical post placed on opposite ends of said plate and the horizontal length between said posts being adjustable.

12. The device of claim 11 wherein said adjustable posts are composed of two components, the first component being a horizontal strip of metal with one end of said strip bent to form a post approximately perpendicular to the horizontal length of said strip in the approximate shape of the letter “L”.

13. The device of claim 11 wherein said adjustable posts are composed of two components, the first component being a horizontal strip of metal that is formed by a bending one end of said metal strip to form a curve in approximately the shape of a half circle which at the apex of the half circle, turns into a straight vertical post approximately perpendicular, and extending down to, the horizontal length of said metal strip in the approximate shape of the letter “D”.

14. The device of claim 11 wherein the curve formed on one end of said plate forms is made in the shape of any geometric figure.

15. The device of claim 11 wherein said posts of the first component has a sheet of rubber padding attached by adhesive.

16. The device of claim 11 wherein said adjustable posts of claim 9 are composed of two components, the second component being metal which is bent or molded to be a form-fitted hollow enclosure which fits over, and may be slid along, the horizontal length of said first component.

17. The device of claim 11 wherein the shape of the enclosure of the second component is in the approximate shape of a rectangle.

18. The device of claim 11 wherein said second component of the device has a vertical post welded to the top side and at least one threaded hole drilled on the underside.

19. The device of claim 11 wherein said vertical post of the second component has a sheet of rubber padding attached with adhesive.

20. The device of claim 11 wherein said sheet of rubber padding on the vertical post of the second post has a protrusion.

21. The device of claim 11 wherein said posts of said component parts one and two are pressed against the front and rear surfaces of the chin spoiler and at least one threaded screw is inserted into said bottom threaded hole or holes to prevent lateral movement of the second component along the length of the first component, thus clamping the device to said chin spoiler.

22. The device of claim 11 wherein the adjustable post of the second component at least one threaded hole that allows for the insertion of a threaded screw such as to press against an interior surface of said chin spoiler.

23. A method of protecting the front chin spoiler of an automobile, comprising:
(a) providing a device consisting of a metal plate with at least one vertical post on each end wherein the horizontal length between said posts may be adjusted and locked into position,
(b) providing an automobile chin spoiler having a front and back surface,
(c) pressing one said vertical post against the exterior and one said vertical surface against the interior of said chin spoiler and locking said posts from moving, thus clamping said posts against the automobile chin spoiler.
